(19) United States
(12) Patent Application Publication
(10) Pub. No.: US 2024/0270539 A1
(43) Pub. Date: Aug. 15, 2024

(54) SUPPORT STRUCTURE OF AN ESCALATOR OR A MOVING WALKWAY

(71) Applicant: INVENTIO AG, Hergiswil (CH)

(72) Inventors: Roland KUBIK, Steinbrunn (AT); Christoph MAKOVEC, Wiener Neustadt (AT); Alexander PFEILER, Wien (AT); Richard SCHUETZ, Wien (AT); Andrzej STAWNIAK, Wien (AT); Georg WAGENLEITNER, Roßleithen (AT)

(21) Appl. No.: 18/568,473

(22) PCT Filed: Jun. 1, 2022
(86) PCT No.: PCT/EP2022/064867

§ 371 Date: Dec. 8, 2023

(30) Foreign Application Priority Data
Jun. 11, 2021 (EP) 21178925.0

(51) Int. Cl. B66B 29/00; A62B 35/00; B66B 23/00

(52) U.S. Cl. CPC B66B 29/00; A62B 35/0068; B66B 23/00

(57) ABSTRACT

A support structure of an escalator or a moving walkway with at least two attachment devices for personal protective equipment, which attachment devices are spaced apart from another at most by a safety distance, welded, soldered or riveted to the support structure and preferably color-coded, are arranged in a central region of the support structure.

### TECHNICAL FIELD

The present disclosure relates to a support structure of an escalator or a moving walkway.

### SUMMARY

An escalator or moving walkway is a passenger transport system having moving surface segments that are connected to form an endless chain and can be revolved by a drive along a guide to transport people. The surface segments are arranged one behind the other with almost no gaps, at least on an upper side of the passenger transport system. The passenger transport system has two end regions and a central region. At least in the end regions, the passenger transport system is connected to a building. At the end regions, the surface segments appear and disappear under a comb plate and an adjoining floor covering. The end regions are usually aligned horizontally.

In the case of the escalator, the end regions are arranged on different levels of the building. In the case of the escalator, the central region runs at an angle to the horizontal and connects the levels. In the central region, the surface segments of the escalator form steps. An escalator can be called a moving staircase.

In the case of the moving walkway, the end regions can be arranged at the same height or on different levels. Accordingly, the central part of the moving walkway can be aligned horizontally or at an angle to the horizontal. The central region of the moving walkway is generally less steep than the central region of the escalator. In the case of the moving walkway, the surface segments do not form any steps.

Both the escalator and the moving walkway have a support structure. The support structure can be designed as a framework. The individual components of the passenger transport system, such as the guide, the drive, balustrades, handrails and cladding are connected to the support structure. The support structure is usually prefabricated and lifted into the building. When the end regions of the support structure are connected to the building, further components are assembled and the passenger transport system is completed and ready for operation. In particular, balustrades are often installed only after the support structure has been anchored in the building.

To assemble the components, fitters have to enter the support structure. Because the central region of the passenger transport system often runs freely through the air, the fitters require fall protection. For example, the fitters can secure themselves with large hooks or carabiners directly in the support structure or on structures in the building. Alternatively or in addition, temporary maintenance railings can be clamped to the support structure using special clamping devices. The fitters can also use the temporary maintenance railings to hang their personal protective equipment. The personal protective equipment usually comprises a harness worn on the body and a longer piece of rope attached thereto, the end of which can be hung securely, quickly and easily at a suitable point using a snap hook, for example. The temporary maintenance railings can be gradually removed as the balustrades are installed.

Securing the personal protective equipment to structures in the building that are not specifically provided for this purpose or to structures on the support structure that are not specifically provided for this purpose can, on the one hand, be complex and, on the other hand, can entail a risk of fall protection that is not appropriate to the situation. Installing and then removing temporary maintenance railings may require additional effort. Because the temporary maintenance railings are loose parts during assembly or disassembly, they can be dropped. Parts of the temporary maintenance railing can cause significant damage if dropped. In addition, clamping devices having different clamping cross sections or clamping surfaces are required for different types of structures in order to ensure surface contact with the respective support structure.

WO 2019/185573 A1 describes a fastening device for fastening a temporary maintenance railing to a support structure of a passenger transport system. EP 1 108 675 B1 describes a working method and a protection system for installation personnel who work on a passenger conveyor system.

Among other things, there may be a requirement for improved occupational safety when working on an escalator or a moving walkway. In particular, there may be a requirement for occupational safety, with the help of which safety, particularly for fitters, can be improved during installation in a way that is simple to implement in terms of design, cost-effectiveness and/or reliability.

Such a need can be met by proposing, according to one aspect of the disclosure, a support structure of an escalator or a moving walkway, wherein at least two attachment devices for personal protective equipment, which are spaced apart at most by a safety distance and fixedly connected to the support structure, are arranged in a central region of the support structure. Attachment devices, also referred to as attachment points, are specially created points where personal protective equipment can be attached safely, quickly and easily. The attachment devices usually have a structure on which an eyelet is formed so that the personal protective equipment can be quickly and securely attached thereto but can also be quickly detached again.

Advantageous embodiments are defined in the dependent claims and described in the description.

A support structure can be a structural component of a passenger transport system in the form of an escalator or a moving walkway. The support structure can be a framework. The support structure can have upper chords, lower chords, struts, uprights and cross braces as support structure components. The upper chords and lower chords can be arranged substantially parallel to one another and can run in a main direction of extent of the support structure. The upper chords and lower chords can be connected to one another by struts aligned diagonally to the upper chords and lower chords and/or uprights aligned transversely to the upper chords and lower chords. Upper chords, lower chords, struts, uprights and cross braces can be metal profiles. In particular, the upper chords, lower chords, struts, uprights and cross braces can be metal L-profiles. The upper chords, lower chords, struts, uprights and cross braces can be connected to one another via gusset plates. For example, the upper chords, lower chords, struts, uprights and cross braces can be welded, screwed, pinned and/or riveted.

A central region of the support structure can be arranged between two end regions of the support structure. In the case of an escalator, the central region is aligned at an angle to the horizontal when the support structure is installed. In the case of a moving walkway, the central region can run horizontally or run diagonally up or down. The end regions can generally be oriented horizontally both in the case of an escalator and in the case of a moving walkway. The support structure can have connection points to a building at the end regions. Likewise, lifting points for lifting the support structure can be arranged at the end regions.

An attachment device for personal protective equipment is specially dimensioned for this purpose in accordance with applicable standards and regulations. The attachment device can correspond to the European standard EN 365 and/or EN 795, for example. The attachment device for personal protective equipment is a specially designed fixing device that is specially designed for the purpose of fall protection by means of personal protective equipment on the support structure. The attachment device for personal protective equipment is not a mounting point for components of the escalator or moving walkway. It is also not used for attaching lifting gear, such as the lifting points described above. The attachment device is dimensioned in such a way that it can absorb the forces that occur in a standard fall without damage and transfer them to the support structure. For example, the attachment device can be designed for a load of 16 kilonewtons. The attachment device can also be dimensioned for larger forces. The attachment devices presented here remain on the support structure even after the components of the passenger transport system have been installed.

The attachment device has an eyelet. The eyelet can be a through-opening, an opening or a hole into which at least one connecting means of the personal protective equipment can be hung. The eyelet can also be dimensioned to be large enough for two connecting means to be attached by different people at the same time. The eyelet can be regular or irregular in shape.

The attachment device can be highlighted in color by a signal color or a contrasting color to a basic color of the support structure, such that it can be quickly and unequivocally identified by the installation personnel to be secured. In this way, hanging at an unsuitable point on the support structure can be avoided. Because of the attachment devices that are fixedly held in place on the support structure, a fitter can immediately secure himself against falling when entering the support structure without first having to look for a suitable place on the support structure or building or first erecting a temporary maintenance railing.

As already indicated, the personal protective equipment, PPE for short, has, for example, a safety harness and a fall arrester having two separate connecting means and at least one energy-absorbing element. The connecting means can, for example, be retractable and extendable. The energy absorbing element can in part absorb the kinetic energy of a falling body, thus preventing injuries.

A safety distance between two adjacent attachment devices can be specified by the applicable standards and regulations. The safety distance should generally be less than an average arm span of an average human. The safety distance can be, for example, within a range from 0.5 m to 3 m, preferably 1 m to 2 m, and can be 1.2 meters, for example. Due to the arrangement of attachment devices spaced apart from one another at most by the safety distance, each fitter can always reach at least two attachment devices at the same time. The attachment devices can be arranged along the entire length of the support structure, in particular along the entire length of the central region of the support structure, preferably at uniform intervals.

The attachment devices can be arranged on opposite sides of the support structure. The attachment devices can be arranged to be distributed evenly to the right and left of the support structure. The fitter can always hook into a right-hand attachment device and a left-hand attachment device. If the fitter should then fall, his fall will always be stopped by the connecting means attached further away. In this way, a fall height can be reduced. This also reduces any fall energy or kinetic energy to be absorbed. Furthermore, the risk of falling or hitting the ground is reduced.

At least one color-coded anchor device fixedly connected to the support structure for an attachment means for the personal protective equipment can be arranged on at least one end region of the support structure. The anchor device can be spaced at most by the safety distance from an adjacent attachment device. An attachment device requires installation space due to its design as an eyelet. The available space is limited, in particular in the end regions. An anchor device can require substantially less installation space than a attachment device. Like the attachment device, the anchor device is dimensioned according to applicable standards and regulations. The anchor device is a specially designed fixing point that is only intended for the purpose of fall protection by means of a attachment means. The anchor device is not a mounting device for components of the escalator or moving walkway. The anchor device is dimensioned in such a way that it can absorb the forces that occur in a standard fall without damage and transfer them to the support structure. The anchor device may be oversized. The anchor device can stiffen the support structure locally. A component of the support structure can be reinforced in the region of the anchor device. The anchor device remains on the support structure even after the components of the passenger transport system have been installed. The fitter can carry at least one standardized attachment means with him. When entering the end region, the fitter can immediately recognize the anchor device and connect the attachment means he is carrying with him to the anchor device. The fitter can then hang his personal protective equipment on the attachment means because an eyelet is formed thereon, for example. Thus, the anchor device and the attachment means together form an attachment device.

In the end region, at least two anchor devices can be arranged on opposite sides of the support structure. The anchor devices can be arranged to be distributed evenly to the right and left of the support structure. In this way, the fitter can always connect one attachment means to a right-hand anchor device and a left-hand anchor device. If the fitter should then fall, his fall will always be stopped by the connecting means attached further away. In this way, the fall height can be reduced. This also reduces the fall energy to be absorbed. Furthermore, the risk of falling is reduced.

The attachment devices and/or the anchor devices can be arranged in pairs opposite each other. The fitter can always reach at least three attachment devices and/or anchor devices by means of attachment devices and/or anchor devices arranged in pairs at the same height. If two fitters are working together on the same passenger transport system, they can easily climb past each other using attachment devices and/or anchor devices arranged in pairs without having to unhook their personal protective equipment.

The attachment devices and/or anchor devices can be integrally connected to the support structure. The attachment devices and/or anchor devices can be welded to the support structure. The attachment devices and/or anchor devices cannot be removed inadvertently by welded attachment devices and/or anchor devices. Alternatively, the attachment devices and/or anchor devices can also be soldered or glued.

The attachment devices and/or anchor devices can be arranged on at least one of the upper chords of the support structure. Arranged on the upper chord, the attachment devices and/or anchor devices can be clearly visible and easily accessible for the fitter. When the fitter is standing in the support structure, the upper chord can be at approximately chest height. The connecting means are long enough to also allow work on the lower chord. By arranging the attachment devices and/or anchor devices on the upper chord, a fall is caught earlier and the fall height is reduced. This also reduces the fall energy to be absorbed. Furthermore, the risk of falling is reduced.

The support structure can enclose an interior space of the support structure with the upper chords and the lower chords. The attachment devices can be oriented toward an interior space of the support structure. The attachment devices can be aligned in the direction of the interior space. This means that the attachment devices are easily accessible from the interior space. To attach a connecting means, it is not necessary to reach outside of the support structure.

The attachment devices can be cut from sheet material. The attachment devices can each have a stiffening region for local stiffening of the support structure and a tab having an eyelet. A sheet material can be a thick metal sheet. The sheet material can be sheet steel, for example. The attachment devices can, for example, be burned, punched, lasered, water jet cut or milled from the sheet material. A stiffening region can at least in some regions reproduce a profile of the support structure component on which the attachment device is arranged. The stiffening region can be welded to the support structure component. The stiffening region can increase a force introduction surface of the support structure component for introducing the fall energy, such that the support structure is not damaged if a fitter falls. As a result, the support structure can be dimensioned smaller outside of the attachment devices, because the stiffening region stiffens the support structure component on the force introduction surface. The stiffening region can have, for example, two legs arranged in a V-shape, such that the attachment device resembles a butterfly with spread wings. The legs can increase the force introduction surface along a direction of extension of the support structure component. A tab may protrude from the stiffening region. The tab may protrude beyond the support structure component. The tab can be arranged centrally between the legs. The tab can be tongue-shaped. One end of the tab can be rounded. The eyelet can be an opening through the tab. The eyelet can be circular or oval, for example. Likewise, the eyelet can be triangular with rounded corners. The eyelet can be dimensioned large enough to be able to attach two connecting means at the same time. The tab and/or the legs can bend during a fall and thus absorb the energy of a fall. This can protect the support structure component from overloading.

The attachment devices can be cut and bent. The tab can be oriented at an angle to the stiffening region. The attachment device can be designed in particular as a stamped and bent part. The connecting means can be easily hooked into the eyelet thanks to the curved tab. In particular, the tab can be bent upwards. This allows the tab to bend by a greater angular amount in the event of a fall than if the tab were arranged horizontally. This allows the tab to absorb more fall energy.

On at least one of the end regions, which is horizontal in the installed position, at least one color-coded attachment device can be arranged, which is spaced at most by the safety distance from an adjacent attachment device and is fixedly connected to the support structure. The end regions of the support structure can protrude beyond an edge of the building. There can already be a risk of falling at a transition from the end region to the central region. With at least one attachment device in the region of the transition, the fitter can already secure himself at the transition.

The anchor device can have a thread for an attachment means designed as a screw eyelet. The anchor device may include a stiffening region welded to the support structure component. The stiffening region can have a blind hole having the thread. As a result, a weakening of the support structure component by the thread can be avoided. An attachment means designed as a screw eyelet can have a forged eyelet and a threaded pin. The threaded pin can be temporarily connected to the eyelet so that it is rotationally fixed. As a result, the screw eyelet can be screwed into the anchor device without tools. After screwing in, the rotationally fixed connection can be loosened so that the eyelet can rotate independently of the threaded pin. Due to the freely rotatable eyelet, the screw eyelet cannot unscrew itself from the anchor device. Thus, the anchor device and the screw eyelet or attachment means connected thereto together form an attachment device.

The anchor device can have a hole for a attachment means designed as a pawl anchor. The hole can be a through-hole. The hole can be arranged to the side of the support structure component in a separate component. Due to the lateral arrangement, a weakening of the support structure component through the hole can be avoided. A pawl anchor may include a movable pawl, a flexible shaft, and an eyelet. The pawl can be arranged at one end of the shaft. The eyelet can be arranged at an opposite end of the shaft. The pawl can be inserted into the hole in an unlocked position. Behind the hole, the pawl can be moved to a locked position. A spring on the shaft can hold the pawl in the locked position. In the locked position, the pawl may be arranged transversely to the hole and abut a rear of the anchor device. Thus, the pawl anchor can no longer be pulled out of the anchor device. To remove the pawl anchor, the spring can be compressed and the pawl returned to the unlocked position. Then the pawl anchor can be removed from the anchor device again.

The anchor device can be arranged on an underside of an upper chord of the support structure. By arranging it on the underside, a lateral load on the attachment means can be prevented in the event of a fall.

It should be noted that some of the possible features and advantages of the disclosure are described herein with reference to different embodiments of methods on the one hand and of devices on the other hand. A person skilled in the art will recognize that the features can be suitably combined, adapted, or exchanged in order to arrive at further embodiments of the disclosure.

### BRIEF DESCRIPTION OF THE DRAWINGS

Embodiments of the disclosure will be described below with reference to the attached drawings; neither the drawings nor the description should be interpreted as limiting to the disclosure.

FIG. 1 shows an illustration of a support structure according to an embodiment;

FIG. 2 shows an illustration of a attachment device on a support structure according to an embodiment; and

FIG. 3 shows an illustration of anchor devices on a support structure according to an embodiment.

The drawings are merely schematic and not true to scale. The same reference signs indicate the same or equivalent features.

### DETAILED DESCRIPTION

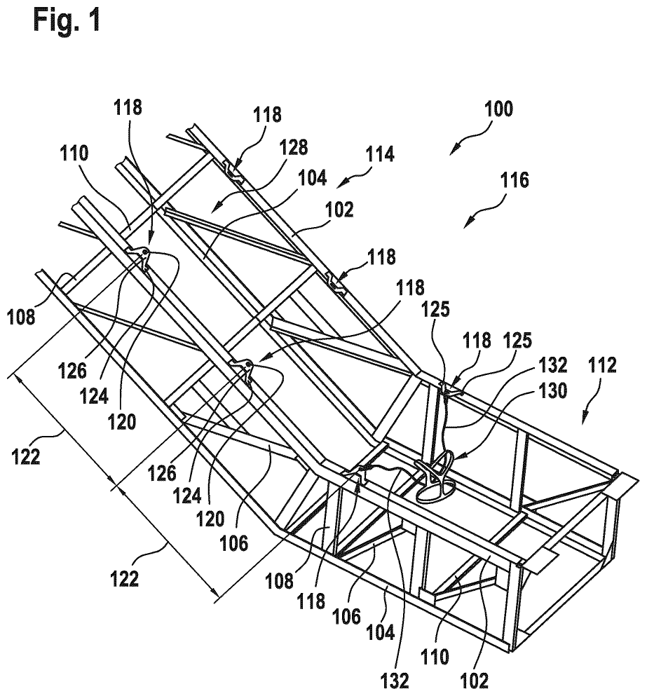

FIG. 1 shows an illustration of a support structure 100 according to an embodiment. The support structure 100 is a framework made up of upper chords 102, lower chords 104, struts 106 and uprights 108 and cross braces 110. The upper chords 102 and lower chords 104 run substantially parallel to one another. The lower chords 104 are connected to one another by the cross braces 110. The cross braces 110 are arranged perpendicular to the lower chords 104. The struts 106 are arranged diagonally to the upper chords 102 and lower chords 104 and each connect one of the upper chords 102 to one of the lower chords 104. The uprights 108 are arranged perpendicularly to the upper chords 102 and lower chords 104 and each connect one of the upper chords 102 to one of the lower chords 104. The uprights 108 are connected by additional cross braces 110.

The support structure 100 has two end regions 112 and a central region 114. In the present embodiment, half of a support structure 100 of an escalator 116 is shown. The central region 114 thereof is oriented obliquely to the end regions 112 in order to overcome a height difference between the two levels connected by the escalator 116. The end regions 112 are aligned horizontally. At the transitions between the end regions 112 and the central region 114, the support structure 100 has a kink in each case. In the case of a moving walkway, the central region 114 can

Attachment devices 118 for personal protective equipment 130 (which are shown only schematically in FIG. 1 and without a fitter) are fixedly connected to the support structure 100 in the central region 114. The attachment devices 118 are dimensioned and designed in such a way that they meet the relevant standards and regulations with regard to their strength. The attachment devices 118 are clearly color-coded. The attachment devices 118 each have an eyelet 120 for at least one connecting means 123 of the personal protective equipment 130. The attachment devices 118 remain on the support structure 100 even after the escalator 116 has been completed.

The attachment devices 118 are arranged at a maximum safety distance 122 from one another. The safety distance 122 is less than an average arm span of an average human. The average arm span may be specified in relevant standards and regulations. Because the distance is limited to less than the safety distance 122, a fitter can always reach at least two of the attachment devices 118 and thus secure himself.

The attachment devices 118 are preferably welded to the support structure 100. Due to the integral connection, fall forces arising in the event of a fall can be safely introduced into the support structure 100. Welding also prevents the attachment devices 118 from being accidentally unscrewed.

In one embodiment, the attachment devices 118 are arranged on both sides of the support structure 100. The attachment devices 118 are arranged on the right and left of the support structure 100. In this way, the fitter can secure himself on both sides at the same time. A fall height can be reduced in this way, because the connecting means that is tightened first always slows down the fall.

In one embodiment, the attachment devices 118 are arranged in pairs opposite one another. In this way, the fitter can always reach at least three of the attachment devices 118 at the same time. If two fitters are working on the escalator 116 at the same time, they can easily pass each other, because one of the fitters can be secured on each side when passing. When the fitters have passed each other, they can secure themselves on either side again.

In one embodiment, the attachment devices 118 are arranged on the upper chords 102. The attachment devices 118 on the upper chords 102 are easily accessible for the fitter because they are in the region of chest height of the standing fitter. The fall height can be reduced through securing on the upper chord 102. In addition, the upper chords 102 are sufficiently dimensioned to absorb the resulting fall energy.

In one embodiment, the attachment devices 118 are cut from sheet material. The attachment devices 118 each have a stiffening region 124 and a tab 126 having the eyelet 120. The stiffening region 124 is fixedly connected to the support structure 100 and locally stiffens the support structure 100 in order to dissipate the fall energy into the support structure 100 without causing damage. The tab 126 protrudes from the stiffening region 124 and the support structure 100. The tab 126 can plastically deform during a fall to absorb some of the energy of the fall.

In one embodiment, the stiffening region 124 has two arranged legs 125. The tab 126 connects both legs 125 to each other. The legs extend away from the tab 126 in a V-shape and thus at an angle to a direction of extension of the support structure 100. The attachment devices 118 are thus designed approximately in the shape of a butterfly. The legs 125 are widened at their ends. At the widening, the legs 125 are approximately as wide as the upper chord 102. Due to the oblique orientation, the legs 125 are aligned with a direction of force to be expected in the event of a fall. The widenings and optionally also the legs 125 are in particular welded onto a surface of the upper chord 102.

In one embodiment, the tabs 126 protrude into an interior space 128 of the support structure 100. As a result, the eyelets 120 can be easily reached by the fitter and the connecting means 132 of the personal protective equipment 130 can align themselves in the eyelet 120 by means of gravity. In the event of a fall, a transverse load on the connecting means 132 can thus be avoided.

In one embodiment, the tabs 126 having the eyelets 120 are bent upwards by approximately 45° out of the planes of the stiffening regions 124. The connecting means 132 can thus be aligned in a plurality of spatial directions with respect to the attachment device 118 without tilting. The bent-up tab 126 can be bent down in the event of a fall in order to dissipate the energy of a fall.

In one embodiment, two further attachment devices 118 are arranged at the transition from the end region 112 to the central region 114. The attachment devices are arranged in the end region 112 and are spaced apart from the adjacent attachment devices 118 of the central region 114 at most by the safety distance 122.

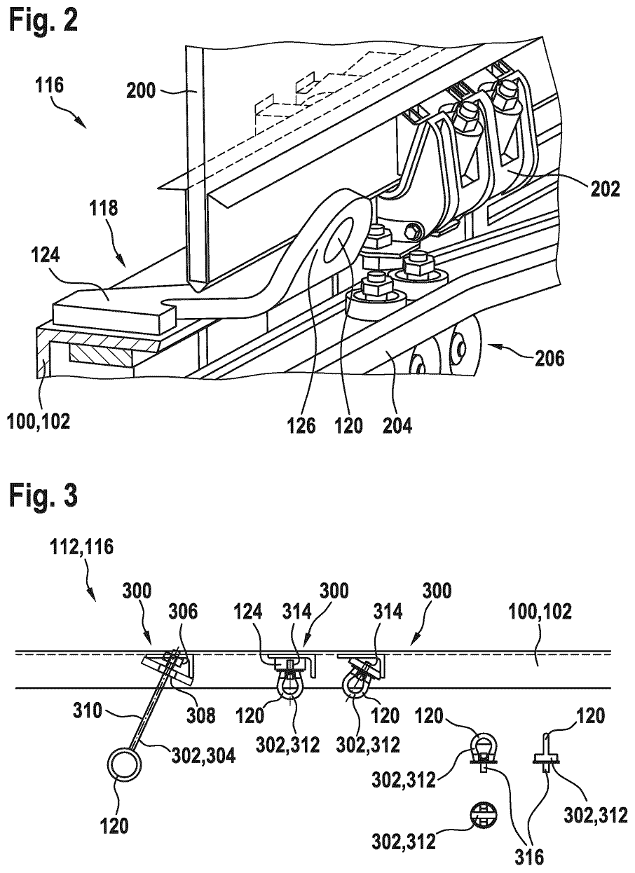

FIG. 2 shows an illustration of a attachment device 118 on a support structure 100 according to an embodiment. The attachment device 118 substantially corresponds to the attachment devices shown in FIG. 1. Here the escalator 116 is already in part installed. A balustrade 200 is attached to the upper chord 102 using balustrade clamps 202. The balustrade 200 takes over the lateral fall protection here. The balustrade clamp 202 is screwed to the upper chord 102 and securely clamps the balustrade 200 between its clamping jaws. The attachment device 118 is arranged between a lower edge of the balustrade 200 and the upper chord 102.

A movable handrail 204 of the escalator 116 runs below the attachment device 118 within the support structure 100. The handrail 204 is guided by handrail guides 206. The handrail guides 206 are installed below the balustrade clamps 202. The handrail guides 206 have support rollers and guide rollers for guiding the handrail 204 laterally. This view clearly shows that the attachment device 118 can easily remain in the escalator 116 and does not have to be removed after the balustrades 200 have been installed, as is the case, for example, with the temporary maintenance railings (not shown) mentioned at the outset.

FIG. 3 shows an illustration of anchor devices 300 on a support structure 100 according to an embodiment. The support structure 100 substantially corresponds to the support structure in FIG. 1. An end region 112 of the support structure 100 is shown here. The anchor devices 300 are dimensioned and designed in such a way that they meet the safety requirements of relevant standards and regulations. The anchor devices 300 are clearly color-coded. If necessary, a mobile attachment means 302 for hanging or attaching the personal protective equipment 130 (see FIG. 1) can be temporarily attached to the anchor devices 300. The anchor devices 300 are only intended for the attachment means 302 and are not used to install components of the escalator 116.

In one embodiment, the anchor devices 300 are arranged on an underside of the upper chord 102. The attachment means 302 can be anchored in the anchor device 300 from below or at an angle below and removed from the anchor device 300 again downward after use. By means of mounting from below, lateral shearing loads on the attachment means 302 can be avoided in the event of a fall.

In one embodiment, the attachment means 302 is a pawl anchor 304. The pawl anchor 304 can be attached to the anchor device 400 without tools. The pawl anchor 304 has a pawl 306 that is inserted into a hole 308 of the anchor device 300 in a longitudinal direction of the pawl anchor 304 and traverses behind the hole 308 and abuts a rear side of the anchor device 300. A shaft 310 of the pawl anchor 304 protrudes on a front side of the anchor device 300 and terminates in an eyelet 120. The connecting means 132 of the personal protective equipment 130 can be hooked into the eyelet 120.

To remove the pawl anchor 304, the shaft 310 is pushed further into the hole 308, the pawl 306 thereby relieved is realigned longitudinally by an integrated mechanism and pulled out of the hole 308 together with the shank 310.

In one embodiment, the attachment means 302 is a screw eyelet 312. The screw eyelet 312 has a threaded pin 316 and an eyelet 120 for the connecting means 132 of the personal protective equipment 130. The threaded pin 316 is screwed into a thread 314 of the anchor device 300. The thread 314 can be an M16 thread, for example. For screwing in and unscrewing, the threaded pin 316 is connected to the eyelet 120 in a rotationally fixed manner. The eyelet 120 can be used as a handle for screwing in and unscrewing without tools. When the threaded pin is screwed into the thread 314, the rotationally fixed connection to the eyelet 120 is released and the eyelet 120 is free to rotate relative to the threaded pin 316. A locking mechanism used in this case (not shown) can be operated without tools and visually indicates its locking status via signal-colored locking elements.

In one embodiment, the thread 314 is designed as a blind hole and is arranged in a stiffening region 124 of the anchor device 300 in order not to cause any notch effects in the support structure 100. The stiffening region 124 is in particular welded to the support structure 100 and is thicker than the blind hole is deep.

Possible embodiments of the support structure 100 described herein or of the escalator 116 or moving walkway formed therewith are described again below with a partially different choice of words.

If an escalator 116 or a moving walkway is delivered without a balustrade 200, the balustrade 200 is installed on site at the premises of the customer. There is a risk of falling here because a complete safety chain, for example in the case of escalators 116 that are installed crossed one above the other in an atrium, is often difficult or impossible to implement because there are no attachment devices for individual safety on the building. Conventionally, no attachment devices are provided on the escalator 116 either.

The attachment devices 118 presented here for securing people by means of personal protective equipment (PPE) 130 can be arranged at defined regular or irregular distances 122 on the framework upper chord 102. The distance 122 is selected in FIG. 1 in such a way that it is possible to be able to attach the personal protective equipment 130 to two consecutive or opposite attachment devices 118 at the same time. Depending on the embodiment, the attachment devices 118 can be arranged on one or both sides of the escalator 116.

With this system, it is possible to hook the personal protective equipment 130 to the next attachment device 118 without having to unhook from the current attachment device 118. Securing up from one attachment device 118 to the next along the escalator 116 is thus possible. This ensures that the defined safety concept for the fitters can be adhered to, which prescribes that they may only enter the unfinished escalator 116 or the unfinished moving walkway if they are secured against falling.

The attachment devices 118 are preferably welded, soldered or glued to the upper chord 102 of the framework 100 or to other escalator structural elements, provided these elements withstand the test forces required by standards.

The attachment device 118 is constructed for the illustrated embodiment in such a way that the upper chord 102 of the framework structure is reinforced or stiffened and thus local overloading of the framework upper chord 102 is prevented when the test force is applied.

The embodiment shown allows a plurality of people to secure themselves simultaneously on the escalator 116 with their personal protective equipment 130 without any additional effort.

The attachment devices 118 are highlighted by colored or other markings in order to rule out accidental securing to components that are not intended for this purpose as far as possible.

These attachment devices 118 are preassembled at the factory and can therefore be used immediately for fall protection without the need for complex assembly work before the escalator 116 is brought in. The attachment devices 118 can be used immediately for fall protection if no attachment devices are provided on the building side.

The attachment devices 118 can be used both for erecting balustrades and for any subsequent repairs or modernization of the systems because the attachment devices 118 remain installed on the escalator 116.

The attachment devices 118 themselves can be produced, for example, by means of laser cutting, flame cutting or water jet cutting. Likewise, the attachment devices 118 can be manufactured as a gravity cast component or with another manufacturing process.

The illustrated attachment devices 118 are designed for connection by means of welding processes to the upper chord 102 in such a way that said attachment devices can be used with all product types. The size and shape of the opening for hanging the personal protective equipment 130 can vary in order to hang one or more snap or screw carabiners.

The permanently installable attachment devices 118 described in the present document allow easy handling and can be used with all types of escalators, are permanently installed on their support structure 100, can also be used for repairs or modernizations and are inexpensive to produce. By using the permanently installable attachment devices 118 presented here, an improvement in work safety and an increase in work efficiency can be achieved.

Finally, it should be noted that terms such as “comprising,” “having,” etc., do not preclude other elements or steps and terms such as “a” or “an” do not preclude a plurality. Furthermore, it should be noted that features or steps which have been described with reference to one of the above embodiments may also be used in combination with other features or steps of other embodiments described above.

1. A support structure of an escalator or a moving walkway, the support structure comprising:
at least two attachment devices for personal protective equipment arranged in a central region of the support structure, wherein the at least to attachment devices are welded, soldered or riveted to the support structure, which attachment devices are spaced apart from one another at most by a safety distance.

2-15. (canceled)

16. The support structure of claim 1, wherein the attachment devices are color-coded.

17. The support structure of claim 1, wherein the attachment devices are arranged on opposite sides of the support structure.

18. The support structure of claim 1, wherein at least one color-coded anchor device fixedly connected to the support structure for an attachment device for the personal protective equipment is arranged on at least one end region of the support structure, wherein the anchor device is spaced from an adjacent attachment device at most by the safety distance.

19. The support structure of claim 18, wherein in the end region, at least two anchor devices are arranged on opposite sides of the support structure.

20. The support structure of claim 18, wherein the anchor device has a thread for an attachment device configured as a screw eyelet.

21. The support structure of claim 18, wherein the anchor device has a hole for an attachment device configured as a pawl anchor.

22. The support structure of claim 18, wherein the anchor device is arranged on an underside of an upper chord of the support structure.

23. The support structure of claim 1, wherein at least one of the attachment devices or the anchor devices is arranged in pairs opposite one another.

24. The support structure of claim 18, wherein the at least one anchor device is welded to the support structure.

25. The support structure of claim 1, wherein the support structure comprises upper chords and lower chords, and wherein the attachment devices or anchor devices are arranged on at least one of the upper chords of the support structure.

26. The support structure of claim 1, wherein the attachment devices are oriented toward an interior space of the support structure.

27. The support structure of claim 1, wherein the attachment devices are cut from a sheet material, and each have a stiffening region for locally stiffening the support structure and a tab having an eyelet.

28. The support structure of claim 23, wherein the attachment devices are cut and bent, wherein the tab is oriented at an angle to the stiffening region.

29. The support structure of claim 1, wherein at least one attachment device spaced from an adjacent attachment device at most by the safety distance and fixedly connected to the support structure is arranged on at least one of the end regions.
